(19) United States
(12) Patent Application Publication
(10) Pub. No.: US 2012/0041921 A1
(43) Pub. Date: Feb. 16, 2012

(54) MECHANISM FOR FACILITATING EFFICIENT BUSINESS RULES MANAGEMENT AND DATA PROCESSING

(75) Inventors: Matthew Canaday, Oakland, CA (US); Michael Lynch, Oakland, CA (US); Lisa Lee, El Cerrito, CA (US)

(73) Assignee: SALESFORCE.COM, INC., San Francisco, CA (US)

(21) Appl. No.: 12/973,714

(22) Filed: Dec. 20, 2010

Related U.S. Application Data
(60) Provisional application No. 61/374,116, filed on Aug. 16, 2010.

(51) Int. Cl. G06F 17/30

(52) U.S. Cl. 707/607; 707/E17.009

(57) ABSTRACT

In accordance with embodiments, there are provided methods and systems for facilitating efficient business rules management and data processing. A method of embodiments includes generating, at a first computing system, configuration settings to customize business rules to process data transactions. The business rules are processed by a business rules engine at a second computing system. The method includes customizing one or more business rules by applying one or more configuration settings to the one or more business rules, and facilitating the business rules engine residing on the second computing system to process one or more data transactions based on the one or more customized business rules. The one or more customized business rules guide processing of the one or more data transactions and provide information relating to how one or more business rules are matched with the one or more data transactions.

### CLAIM OF PRIORITY

This application claims the benefit of U.S. Provisional Patent Application No. 61/374,116, entitled “Business Processor Startup and Maintenance” by Matthew Canaday, et al., filed Aug. 16, 2010 (Attorney Docket No. 8956P038Z), the entire contents of which are incorporated herein by reference and priority is claimed thereof.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### TECHNICAL FIELD

One or more implementations relate generally to business rules and, more specifically, to a mechanism for facilitating efficient business rules management and data processing.

### BACKGROUND

The subject matter discussed in the background section should not be assumed to be prior art merely as a result of its mention in the background section. Similarly, a problem mentioned in the background section or associated with the subject matter of the background section should not be assumed to have been previously recognized in the prior art. The subject matter in the background section merely represents different approaches, which in and of themselves may also be inventions.

In today's business environment, business rules communicated between a Business Rules Engine (BR engine) and an organization (e.g., a business organization or company) are critical to the operations of the business, and must be configurable and verifiable by the users who own the data. For example, various sales lead data transmitted from a form on a website or client application to a business organization over a network may require a team of sales representatives (SRs) to review the sales lead data, including matching the received sales lead data with existing leads, contacts, accounts, and pre-established criteria and rules, to determine whether the received data is acceptable or workable. Typically, this SR-based review process can take up to 20% of SR time. Given the human factor and that various criteria, rules, contact information, etc., can change over time, the aforementioned process is cumbersome, inefficient, and prone to human errors. The business can use a BR Engine with configured business rules to perform the actions taken by SRs to expedite and improve this error-prone process, provided the business has visibility into both the configuration of the business rules and information representing the results of application of the business rules.

In conventional database systems, users access their data resources in one logical database. A user of such a conventional system typically retrieves data from and stores data on the system using the user's own systems. A user system might remotely access one of a plurality of server systems that might in turn access the database system. Data retrieval from the system might include the issuance of a query from the user system to the database system. The database system might process the request for information received in the query and send to the user system information relevant to the request.

Unfortunately, conventional database approaches might become inefficient if, for example, the number of queries received by the database system or the number of interested parties is relatively high.

### SUMMARY

In accordance with embodiments, there are provided methods and systems for facilitating efficient business rules management and data processing. A method of embodiments includes generating, at a first computing system, configuration settings to customize business rules to process data transactions. The business rules are processed by a business rules engine at a second computing system. The method includes customizing one or more business rules by applying one or more configuration settings to the one or more business rules, and facilitating the business rules engine residing on the second computing system to process one or more data transactions based on the one or more customized business rules. The one or more customized business rules guide processing of the one or more data transactions and provide information relating to how one or more business rules are matched with the one or more data transactions.

While one or more implementation techniques are described with reference to an embodiment in which techniques for facilitating efficient business rules management and data processing are implemented in a system having an application server providing a front end for an on-demand database service capable of supporting multiple tenants, the one or more implementations are not limited to multi-tenant databases nor deployment on application servers. Embodiments may be practiced using other database architectures, i.e., ORACLE®, DB2® by IBM and the like without departing from the scope of the embodiments claimed.

Any of the above embodiments may be used alone or together with one another in any combination. One or more implementations encompassed within this specification may also include embodiments that are only partially mentioned or alluded to or are not mentioned or alluded to at all in this brief summary or in the abstract. Although various embodiments may have been motivated by various deficiencies with the prior art, which may be discussed or alluded to in one or more places in the specification, the embodiments do not necessarily address any of these deficiencies. In other words, different embodiments may address different deficiencies that may be discussed in the specification. Some embodiments may only partially address some deficiencies or just one deficiency that may be discussed in the specification, and some embodiments may not address any of these deficiencies.

### BRIEF DESCRIPTION OF THE DRAWINGS

In the following drawings like reference numbers are used to refer to like elements. Although the following figures depict various examples, one or more implementations are not limited to the examples depicted in the figures.

FIG. 1 illustrates a host machine employing business rules management mechanism according to one embodiment;

FIG. 2A illustrates business rules management mechanism according to one embodiment;

FIG. 2B illustrates control objects according to one embodiment;

FIG. 3 illustrates a method for facilitating efficient business rules management and data processing according to one embodiment;

FIG. 4 illustrates a method for facilitating efficient business rules management and data processing according to one embodiment;

FIG. 5A illustrates an exemplary screenshot of Lead Entry Automation Program according to one embodiment;

FIG. 5B illustrates an exemplary screenshot of a business process stage according to one embodiment;

FIG. 5C illustrates an exemplary screenshot of a business process stage rule according to one embodiment;

FIG. 5D illustrates an exemplary screenshot of business process audio log entry details of business process audio log entries of FIG. 5C;

FIG. 5E illustrates an exemplary screenshot of an audit log entry report according to one embodiment;

FIG. 6 illustrates a computer system according to one embodiment;

FIG. 7 illustrates a block diagram of an environment wherein an on-demand database service might be used according to one embodiment; and

FIG. 8 illustrates a block diagram of an embodiment of elements of environment of FIG. 7 and various possible interconnections between these elements according to one embodiment.

### DETAILED DESCRIPTION

Methods and systems are provided for facilitating efficient business rules management and data processing.

One or more implementations provide for efficient business rules management and data processing using efficient business processor startup and maintenance. In one embodiment, business rules are configured using custom objects to automatically filter and verify the business rules and other relevant data. For example, custom objects may be provided using a business rules management mechanism and via a business rules Application Programming Interface (API) to access a BR engine and provide, configure, and control rules there that governing how data is processed. Further, the business rules API may be used to access data in a streamline manner and to make updates to the data as dictated by the business rules. The business rules management mechanism is further used to provide feedback as to what is to be done (e.g., update, delete, etc.) to each piece of data (including various data transactions) and to provide detailed information about such decisions. This way, a user (e.g., an employee of the organization, such as a human resources manager, a software developer, an accountant, a project team, etc.) can not only view the data, but also review any issues that might have or are likely to occur while processing the data as well as to understand the current state of the business rules engine without requiring a separate login or a troubleshooting tool. The user may also choose to update and test the business rules as desired or necessitated.

A business rules engine includes software to execute various business rules in a runtime environment (e.g., any computing system that runs an operating system (e.g., Microsoft® Windows®, Linux®) that supports a runtime environment, such as JAVA® or the like. These business rules may include any number and variety of rules, such as business rules relating to company policy, employment policy, federal and state laws and regulations, accounting practices, ethics, etc.

As used herein, the term multi-tenant database system refers to those systems in which various elements of hardware and software of the database system may be shared by one or more customers. For example, a given application server may simultaneously process requests for a great number of customers, and a given database table may store rows for a potentially much greater number of customers. As used herein, the term query plan refers to a set of steps used to access information in a database system.

Next, mechanisms and methods for facilitating efficient business rules management and data processing will be described with reference to example embodiments.

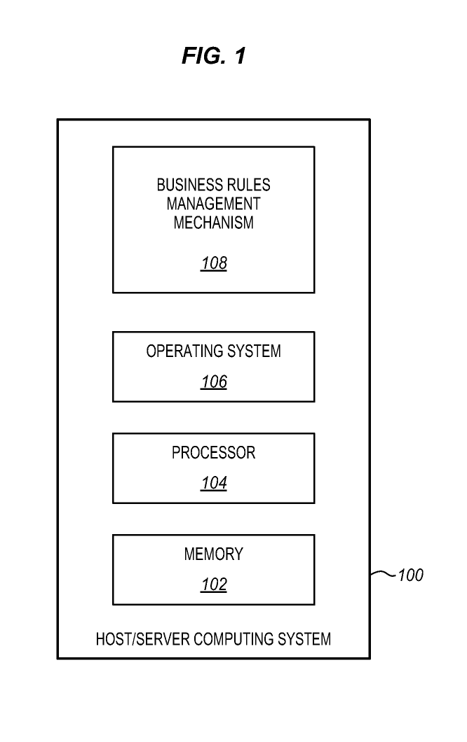

FIG. 1 illustrates a host machine 100 employing business rules management mechanism 108 according to one embodiment. Host machine (e.g., server computing system) 100 comprises a computing platform, which may be capable, for example, of working with a standard operating system 106. Operating system 106 serves as an interface between any hardware or physical resources of the host machine 100 and a user. In some embodiments, base hardware platform may include a memory device 102, a processor 104, network devices, drivers, etc. Host machine 100 may include a server computing system or a client computing system and further, terms like “machine”, “device”, “computer”, “computing device”, and “computing system” are used interchangeably and synonymously throughout this document.

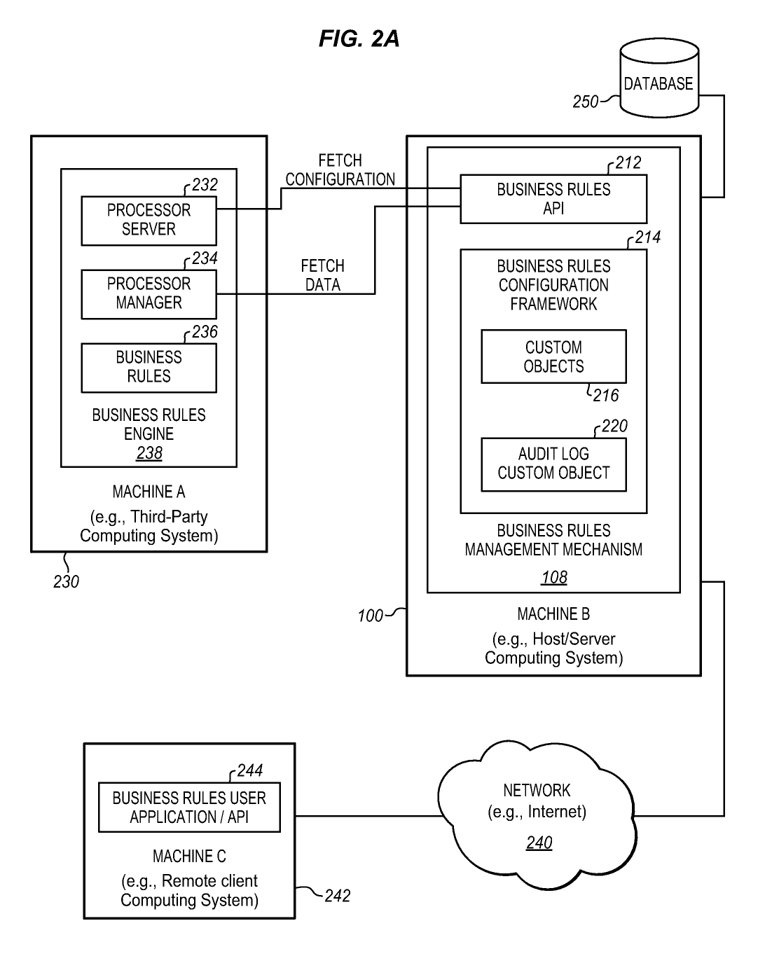

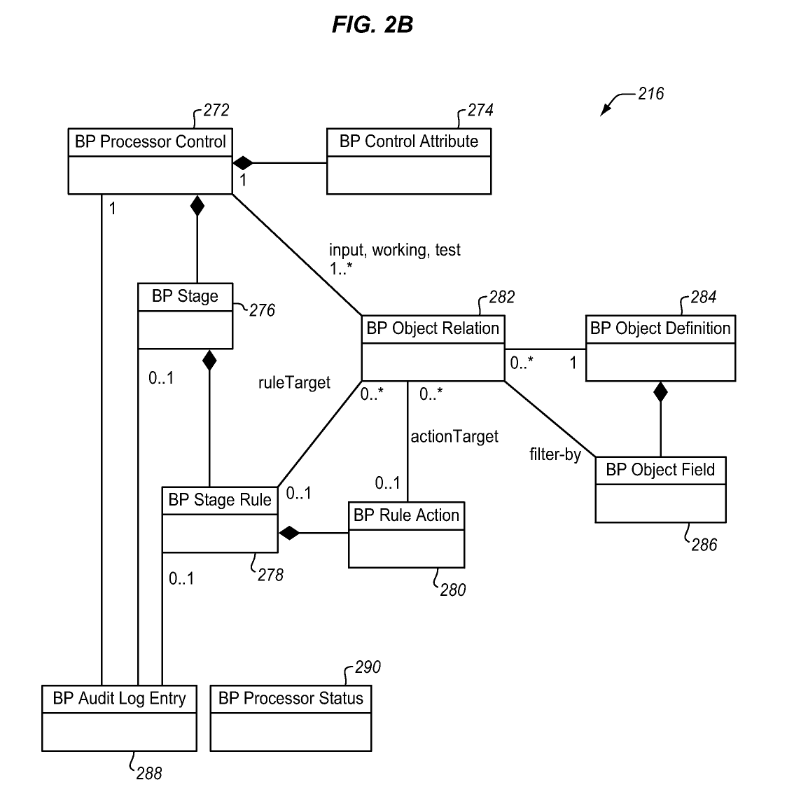

In one embodiment, the host machine 100 employs business rules management mechanism (management mechanism) 108 to facilitate configuration and customization of business rules to process data and retrieve and report on actions performed on the data by a business rules engine (not shown here, but shown in FIG. 2). Further, the management mechanism 108 allows for new configurations for business rules to be generated, maintained and monitored throughout and for an organization (e.g., a business organization or company, etc.) for processing its data as desired or necessitated. Data may include various business data transactions, such as hiring or terminating an employee, allocating business travel expense to an employee, changing health insurance due to marriage or childbirth relating to an employee, providing free shipping on purchased items to a customer for buying a particular item or spending more than a certain pre-determined amount, processing a bad check written by a client, etc. These data transactions and their relevant data are then matched with the existing or, in one embodiment, customized business rules to determine how a data transaction is to be properly handled. If a business rule matches a data transaction, the transaction is successfully processed and completed and stored in a database or, if none of the business rules matches the data transaction, the data transaction is regarded a failure and certain failure actions are taken. Embodiments of these processes will be further described with reference to the subsequent figures.

FIG. 2A illustrates business rules management mechanism 108 according to one embodiment. In one embodiment, business rules management mechanism 100 is hosted by machine B 100 to perform management of business rules including customizing business rules by performing monitoring, configuring, retrieving, and reporting of business rules. As illustrated, machine A 230 (e.g., a third-party computing system that supports JAVA and runs Windows or Linux, etc., as described earlier) hosts a business rules engine 238 retrieving and consuming business rules 236 (stored at and retrieved from a database associated with machine B 100), a processor server 232 (fetches the configurations from machine B 100), and a processor manager 234 (fetches data from machine B 100, processes the data through business rules 236, updates the data on machine B 100, and creates audit log entries on machine B). Machine A 230 is in communication with machine B over a network, such as the Internet, and similarly, machine B 100 is shown as in communication with machine C 242 (e.g., a remote client computing system) over a network 240 (e.g., the Internet). For example, machine B 100 may be part of several machines of a cloud computing network and a user (as defined earlier as including, but not limited to, an employee of the organization, such as a human resources manager, a software developer, an accountant, a project team, etc.) of machine C 242 can access the relevant information about business rules 236 and their implementation to the data at a database via a website (e.g., salesforce.com) and further via a client-based business rules user application or API 244 and view it through a display device.

In one embodiment, the management mechanism 108 includes a business rules configuration framework (framework) 214 including custom objects 216 (e.g., salesforces.com custom objects). The management mechanism 108 further includes a business rules API 212 and an audit log custom object 220. Further, machine B 100 is in communication with the database 250 that holds data as defined earlier as well as configuration settings (including new configuration settings, changes to existing configuration settings, etc., relating to the business rules 236). In one embodiment, a user, using machine C 242 and its business rules user application/API 244, generates a particular set of configuration to be applied to the business rules 236. This generation of a configuration set may include new configuration settings proposed by the user to be applied to the business rules 236, changes to or deletion of one or more existing configuration settings, control commands (such as starting, stopping, or testing the configuration), etc. This is so the business rules 236 can be properly configured and customized and appropriately applied to various data transactions through the framework by any valid user of Machine B with access to the framework. As aforementioned, the data, the data transactions, and configuration settings may be stored at the database 250.

In one embodiment, a processor server 232 of the business rules engine 238 contacts the management mechanism 108 via the business rules API 212 to extract configuration settings from the database 250. These configuration settings are generated using the custom objects 216 as provided by the framework 214. These custom objects 216 will be further described with reference to FIG. 2B. For each set of the business rules 236 received and the extracted or fetched configuration settings, the processor server 232 launches a processor manager 234 of the business rules engine 238. The processor manager 234 analyzes data transactions as defined by the business rules 236 and then applies the relevant business rules 236 to the relevant data transactions. The business rules 236 are used to define data transactions (e.g., data input) as they go through various stages and processes, and what to do with one or more data transactions if a match with one or more business rules is found or not found. In one embodiment, the business rules API 212 facilitates access to data stored and configuration settings stored at the database 250. As aforementioned, these configuration settings are generated using the custom objects 216 and used to process one or more data transactions provided by the data. Further, the database 250 may be, local or remotely, a part of the organization hosting machine B 100, allowing secured access to any data and configuration settings at the database 250 as well as to any business rules 236 and audit log custom object 220 stored at the database 250. It is contemplated some or all of the business rules 236 (or their duplicates) and the audit log custom object 220 may be stored at the database 250.

The framework 214, in one embodiment, provides customization and management of the business rules 236 using configuration settings to facilitate processing of business data transactions so that the data may be created, updated, and/or deleted within and as desired and/or necessitated by the home organization (e.g., a business organization, such as salesforce.com, as described previously). The framework 214 defines custom objects 216 to control processing of data transactions such that each set of custom objects 216 defines each stage of the data transaction processing as well as any number of business rules 236 governing the data transaction processing (e.g., how the processing proceeds with what process actions or whether it ought to be stopped, etc.).

The audit log custom object 220, in one embodiment, provides an audit trail of various actions taken during the processing of each data transaction. For example, an instance of the audit log custom object 220 may provide sufficient information to tie or link or map a specific process action taken during a particular data transaction processing stage of a particular data transaction to a business rule 236 matching with or responsible for governing that particular processing stage. This way, a user can generate extensively detailed reports relating to each processing stage and the relevant entities (e.g., one or more business rules 236 and/or one or more applicable configuration settings) to provide a comprehensive feedback on how the data relating to the data transactions were updated.

FIG. 2B illustrates control objects 216 according to one embodiment. In one embodiment, the custom objects 216 are used by the framework 214 to define and control data transactions processing using the business rules 236. For example, custom objects 216 can be used by the framework 214 to introduce a new configuration setting to customize one of the application business rules of the business rules 236 as it applies to a particular data transaction. Then, using the processor server 232 and the processor manager 234 at the business rules engine 238, the data transaction is processed using the customized business rule of the business rules 236. Various actions taken during the data transaction process as well as the results (e.g., success or failure) of the data transaction process are then recorded as instances of the audit log custom object 220.

In one embodiment, the custom objects 216 may be particular to an organization, such as salesforce.com custom objects, and include: (1) a business process (BP) process control custom object 272 to provide basic control and status for the processor manager 234 and tie together various data transaction processing stages, business rules 236, and process actions that define a business rule configuration; (2) a BP control attribute custom object 274 to describe attributes that can be used when processing data transactions (e.g., “recentActivity=30” days); (3) a BP stage custom object 276 to define a single suite of the business rules 236 applied to data or data transactions, such as performing a set of logically related steps; (4) a BP stage rule custom object 278 to define a single step of a data transaction process, including the definition of success and failure of a data transaction process, what actions to be taken in case of the success or failure, and what is the next stage in the data transaction process (e.g., next business rule to be applied, next stage, whether to terminate the data transaction process, etc.); and (5) a BP rule action custom object 280 to define a process action taken on the data transaction, such as creating new data, updating existing data, deleting existing data. The BP rule action 280 also informs the engine whether an audit log entry should be created when the action is taken. Note that this mechanism can be self-annealing in that it may modify any BP configuration component noted in FIG. 2B, as these configuration components are also accessible as data through the Business Rules Management Mechanism 108. For example, an action might be taken to start or stop the processing of business rules 236 by updating the BP process control custom object 272, or the way data are processed might be altered by modifying a BP control attribute custom object 274 or other component.

The custom objects 216 further include: (6) a BP object relation custom object 282 to define where a custom object definition is used in the data transaction process and provide a context in which the definition is applied, such as how a custom object 216 is initialized and/or filtered using information already gathered during the data transaction process; (7) a BP object definition custom object 284 to describe how to retrieve, build, or update a custom object 216 for use in a process action, business rules 236, and BP processor control custom object 272; (8) a BP object field custom object 286 provides a description of how an individual field is created or populated, which can be used in API searches, fields copied or derived from other custom objects accessible to the business rules 236, fields whose values are fixed, or field whose values are derived from a formula or function; (9) a BP audit log entry custom object 288 is used to define a structure for audit log entries, such as associating a log entry with the BP processor control custom object 272, process stage, business rules 236 and action responsible for the process actions taken, if applicable; and (10) a BP processor status custom object 290 that defines various attributes governing a status report for various data transaction processes, process stages, and/or business rules 236 running on each process control server 232. Further, error and warning log entries created by the business rules engine 238, while processing data transactions, are attached to the BP processor status custom object 290 for review by a user at the organization.

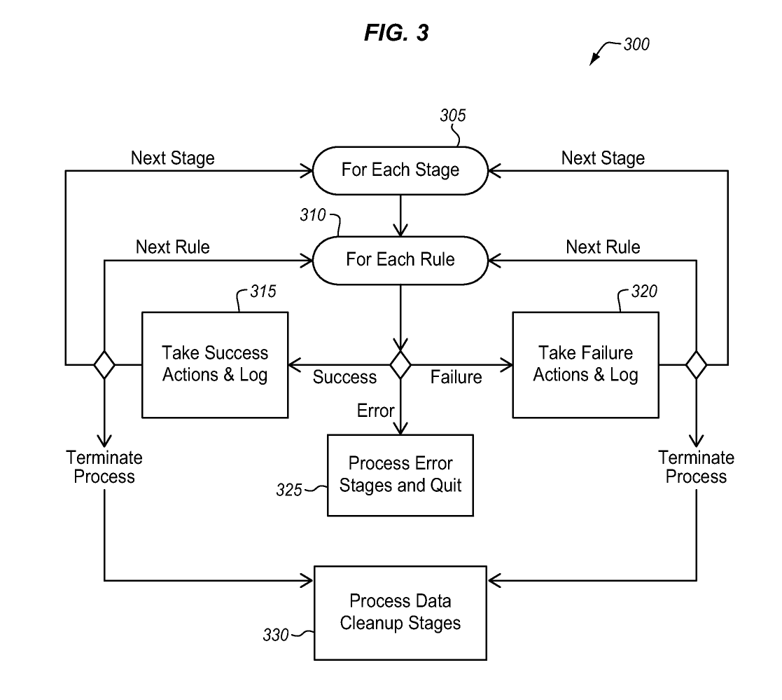

FIG. 3 illustrates a method 300 for facilitating efficient business rules management and data processing according to one embodiment. Method 300 may be performed by hardware, software, or a combination thereof. In one embodiment, method 300 is performed by business rules management mechanism 108 of FIG. 1.

Method 300 begins with a first stage of a data transaction process at block 305. At block 310, the process attempts to match the input data of a data transaction to a business rule. If the match succeeds, success process actions are taken and an appropriate instance of the audit log custom object 220 is created at block 315. If the match fails, failure process actions are taken and an appropriate instance of the audit log custom object 220 is created at block 320. Based on success or failure, a business rule configuration setting then (via a processing module) facilitates the business rules engine to proceed on to the next business rule in the current stage, the next stage, or terminate the data transaction process. If the process is terminated and/or failure is indicated, the business rules engine applies an appropriate data cleanup stage to ensure the data is properly handled, such as in case no business rules have matched the data transaction, at block 330. If, at any time, an error occurs, the management mechanism can proceeds to any number of error handling stages and subsequently quit the process, at block 325, or call through to the data cleanup stages if no appropriate error handling stage exists at block 330.

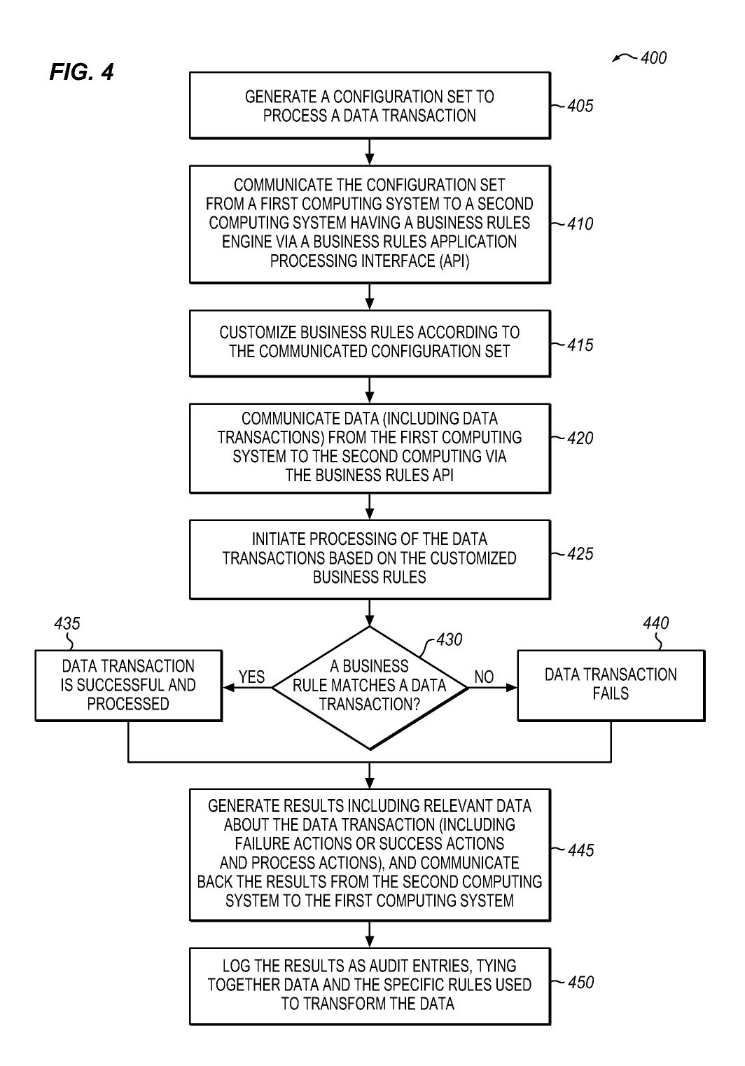

FIG. 4 illustrates a method 400 for facilitating efficient business rules management and data transaction processing according to one embodiment. Method 400 may be performed by hardware, software, or a combination thereof. In one embodiment, method 400 is performed by business rules management mechanism of FIG. 1.

Method 400 starts with generating a configuration set to process a data transaction in a particular way as is desired or necessitated by an organization at block 405. Generating the configuration set includes creating new business rules and adding them to existing business rules, updating or changing one or more of existing business rules, and/or deleting one or more of existing business rules. At block 410, the configuration set is communicated, via a business rules API, to a processor server of a business rules engine. At block 415, the business rules are customized (e.g., added, updated, or deleted) according to the communicated configuration set. At block 420, data, including data transactions and their relevant input data, is communicated, via the business rules API, to the business rules engine.

At block 425, in one embodiment, processing of the data transactions is initiated based on the customized business rules. In one embodiment, a processing module of the management mechanism triggers a processor manager of the business rules engine to initiate the processing of the data transactions. At block 430, a determination is made as to whether a business rule matched a data transaction. If a match is made, the data transaction is processed, including performing certain process actions on the data transaction according to the matched customized business rule at block 435. If a match is not made, the data transaction fails and its processing is not performed at block 440. Either way, at block 445, the relevant data about the data transaction and its success or failure is communicated back to the management mechanism where the results of the data transaction as well as the relevant information about each of the process actions (e.g., success or failure actions) performed on the data transaction are logged into an audit log custom object. At 450, all relevant audit log custom object instances are provided to a user via a user application and/or API, including displaying instances of the audit log custom object using a display device on a client machine.

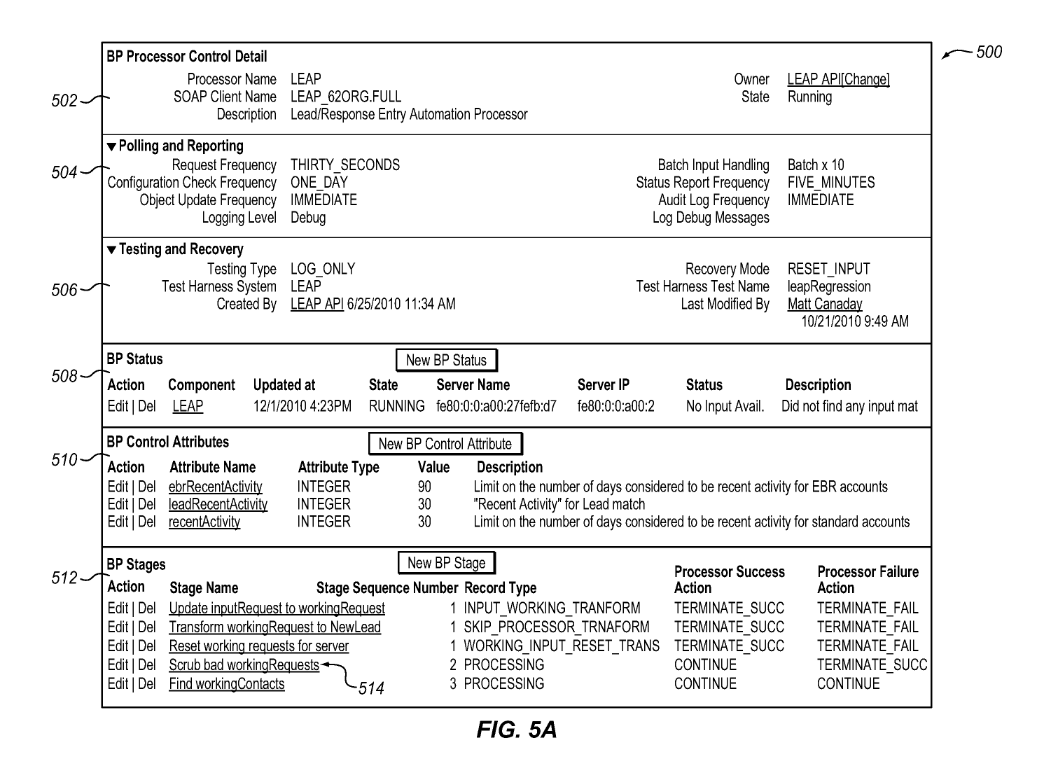

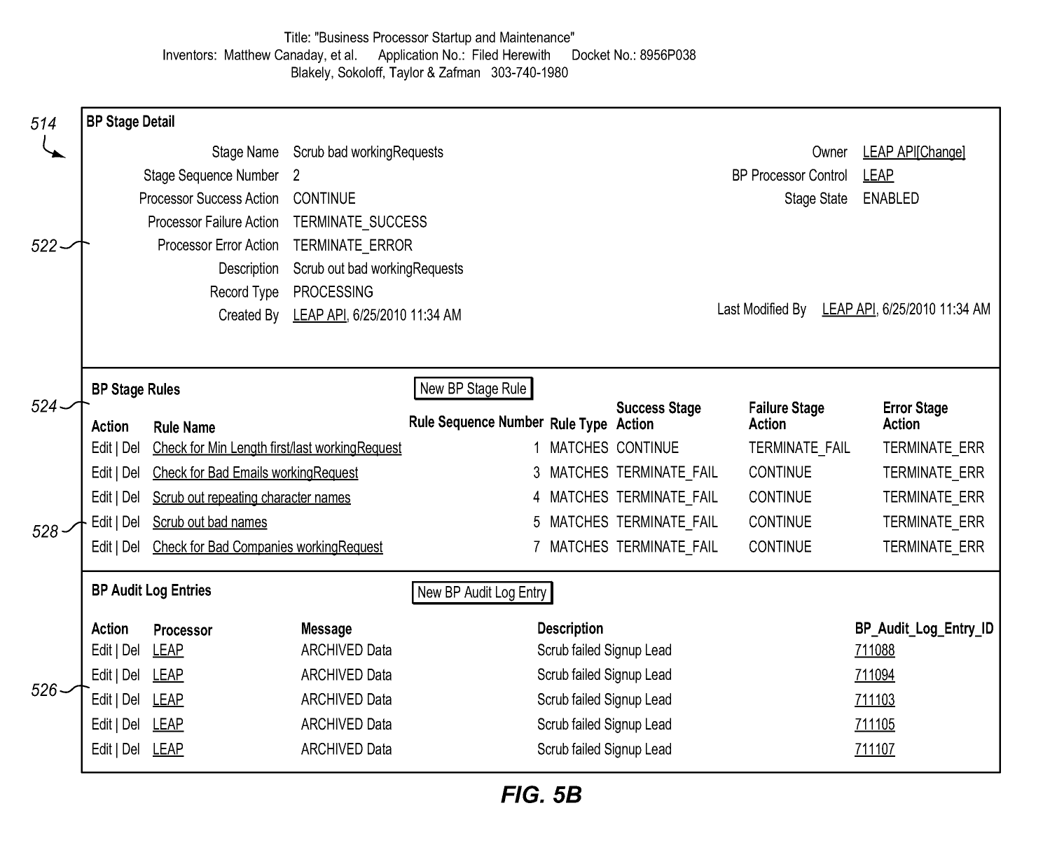

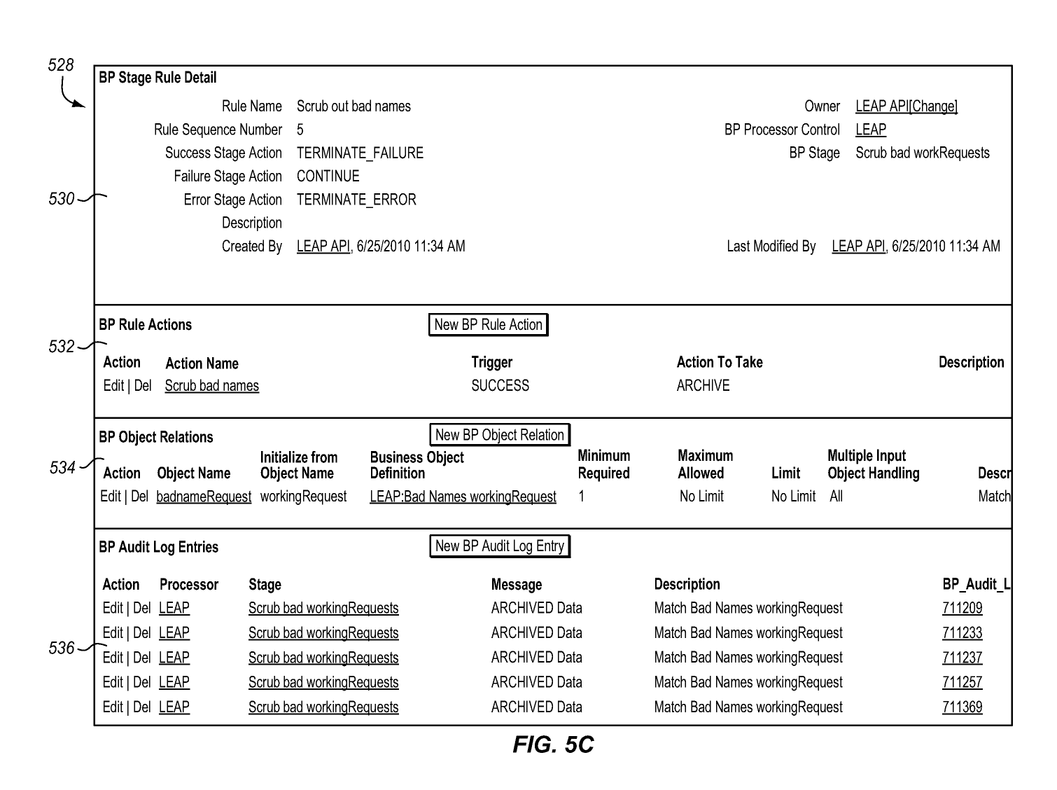

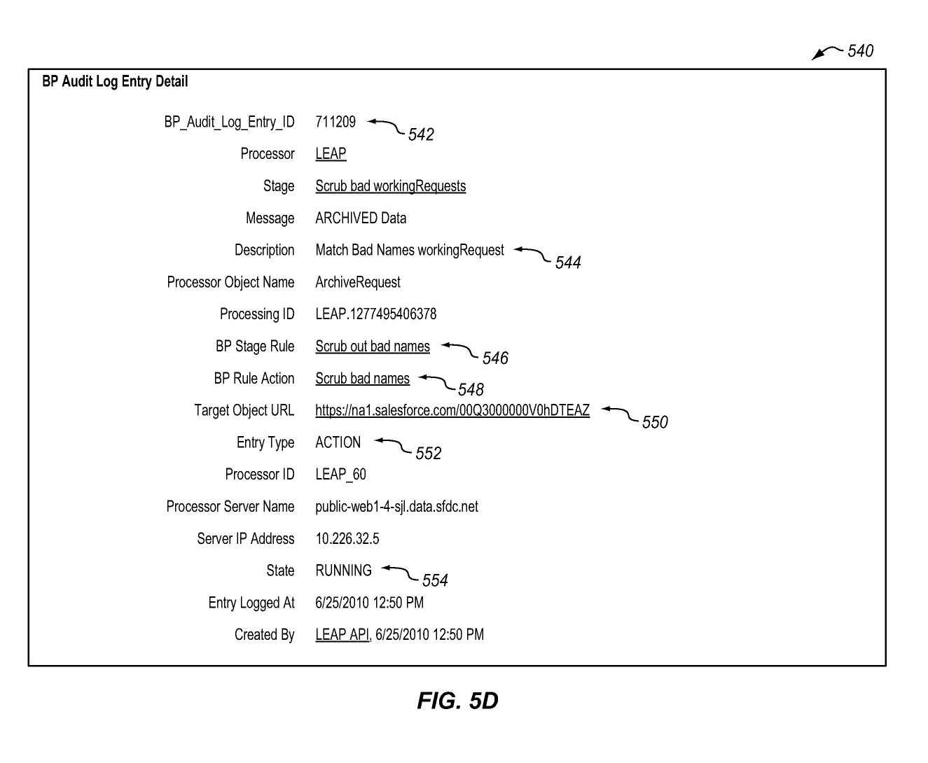

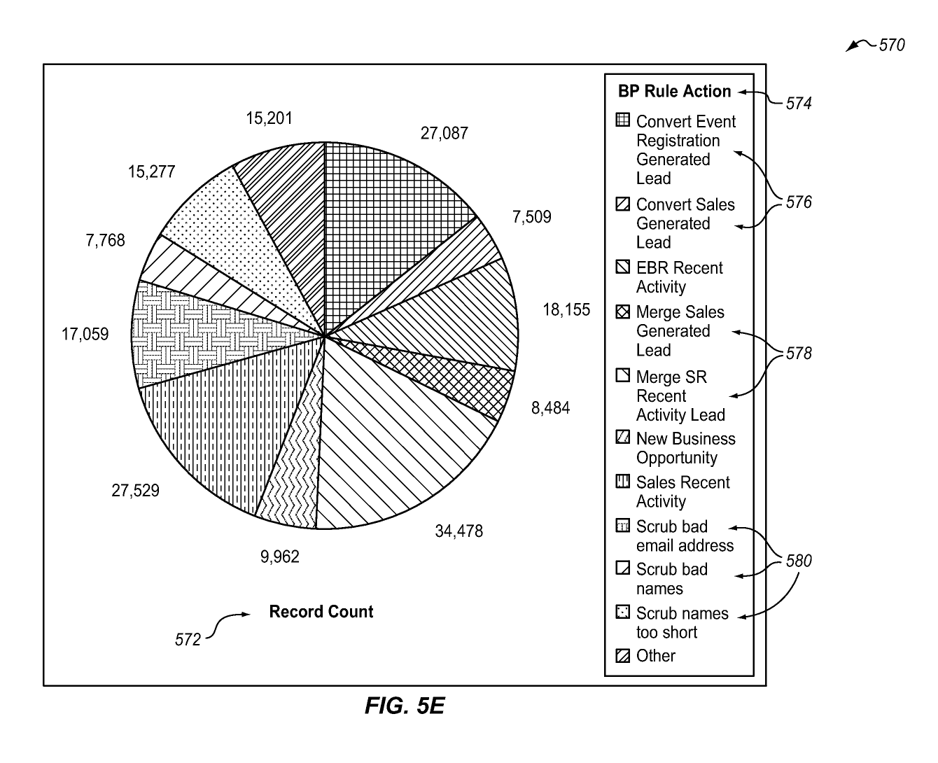

FIG. 5A illustrates an exemplary screenshot of Lead Entry Automation Program (LEAP) 500 according to one embodiment. One use of the framework 214 of FIG. 2A is to implement the LEAP rule set which represents business rules configuration for processing Lead data transactions. LEAP 500 further represents the top-level BP processor control custom object 272 that shows BP process control details 502 of LEAP 500 as well as BP status 508 relating to BP status custom object 290, BP control attributes 510 relating to BP control attributes custom object 274, and BP stages 512 relating to BP stage custom object 276 as illustrated in FIG. 2B. LEAP 500 further illustrates polling and reporting 504 and testing and recovery 506 of various data transactions and their processes. As an example, certain details of scrub bad workingRequests 514 stage of the BP stages 512 are shown in FIG. 5B.

FIG. 5B illustrates an exemplary screenshot of a BP stage 514 according to one embodiment. BP stage scrub bad workingRequests 514 illustrates certain BP stage details 522 as well as BP stage rules 524 relating to BP stage rule custom object 278 (of FIG. 2B) that make up the BP stage 514. BP stage 514 further illustrates BP audit log entries 526 relating to BP audit log entry custom object 288 of FIG. 2B. One exemplary BP stage rule of BP stage rules 524 is scrub out bad names 528 which is further illustrated in FIG. 5C.

FIG. 5C illustrates an exemplary screenshot of a BP stage rule 528 according to one embodiment. BP stage rule 528 illustrates certain BP stage rule details 530, BP rule actions 532 relating to BP rule action custom object 280, BP object relations 534 relating to BP object relations custom object 282, BP audit log entries 536 relating to audit log entry custom object 288 of FIG. 2B. Details of BP audit log entries 536 are illustrated in FIG. 5D.

FIG. 5D illustrates an exemplary screenshot of BP audio log entry details 540 of BP audio log entries 536 of FIG. 5C. BP audio log entry details 540 provide certain details of BP audio log entries 536, such as BP audio log entry identification (ID) 542, log entry description 544, the applicable BP stage rule 546, the applicable BP rule action 548, target object Uniform Resource Locator (URL) 550, log entry type 552, log entry state 554, and the like.

FIG. 5E illustrates an exemplary screenshot of an audit log entry report 570 according to one embodiment. The report 570 is provided by summarizing relevant audit log entries using a reporting mechanism of the host organization (e.g., salesforce.com reporting mechanism). This report 570 provides counts 572 of various data transactions (e.g., sales leads) as processed through the top performing audited actions 574 since the data transaction processing was started by LEAP. Various BP rules actions 574 include convert 576, merge 578, scrub 580, etc.

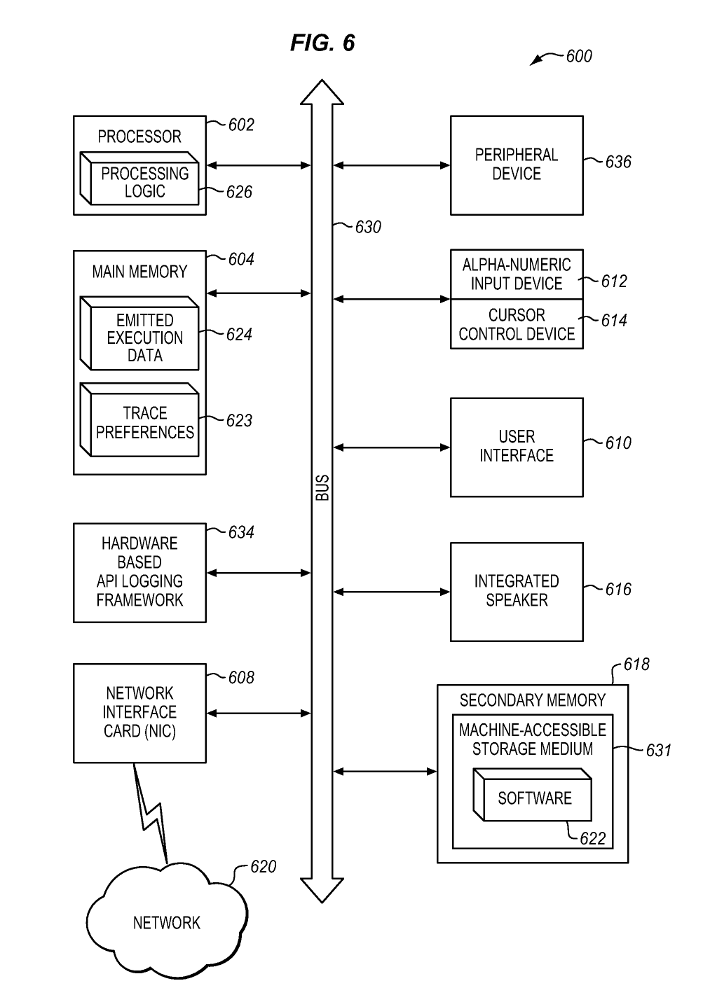

FIG. 6 illustrates a diagrammatic representation of a machine 600 in the exemplary form of a computer system, in accordance with one embodiment, within which a set of instructions, for causing the machine 600 to perform any one or more of the methodologies discussed herein, may be executed. In alternative embodiments, the machine may be connected (e.g., networked) to other machines in a Local Area Network (LAN), an intranet, an extranet, or the Internet. The machine may operate in the capacity of a server or a client machine in a client-server network environment, or as a peer machine in a peer-to-peer (or distributed) network environment or as a server or series of servers within an on-demand service environment, including an on-demand environment providing multi-tenant database storage services. Certain embodiments of the machine may be in the form of a personal computer (PC), a tablet PC, a set-top box (STB), a Personal Digital Assistant (PDA), a cellular telephone, a web appliance, a server, a network router, switch or bridge, computing system, or any machine capable of executing a set of instructions (sequential or otherwise) that specify actions to be taken by that machine. Further, while only a single machine is illustrated, the term “machine” shall also be taken to include any collection of machines (e.g., computers) that individually or jointly execute a set (or multiple sets) of instructions to perform any one or more of the methodologies discussed herein.

The exemplary computer system 600 includes a processor 602, a main memory 604 (e.g., read-only memory (ROM), flash memory, dynamic random access memory (DRAM) such as synchronous DRAM (SDRAM) or Rambus DRAM (RDRAM), etc., static memory such as flash memory, static random access memory (SRAM), volatile but high-data rate RAM, etc.), and a secondary memory 618 (e.g., a persistent storage device including hard disk drives and persistent multi-tenant data base implementations), which communicate with each other via a bus 630. Main memory 604 includes emitted execution data 624 (e.g., data emitted by a logging framework) and one or more trace preferences 623 which operate in conjunction with processing logic 626 and processor 602 to perform the methodologies discussed herein.

Processor 602 represents one or more general-purpose processing devices such as a microprocessor, central processing unit, or the like. More particularly, the processor 602 may be a complex instruction set computing (CISC) microprocessor, reduced instruction set computing (RISC) microprocessor, very long instruction word (VLIW) microprocessor, processor implementing other instruction sets, or processors implementing a combination of instruction sets. Processor 602 may also be one or more special-purpose processing devices such as an application specific integrated circuit (ASIC), a field programmable gate array (FPGA), a digital signal processor (DSP), network processor, or the like. Processor 602 is configured to execute the processing logic 626 for performing the operations and functionality of business rules management mechanism 108 as described with reference to FIG. 1 and other figures discussed herein.

The computer system 600 may further include a network interface card 608. The computer system 600 also may include a user interface 610 (such as a video display unit, a liquid crystal display (LCD), or a cathode ray tube (CRT)), an alphanumeric input device 612 (e.g., a keyboard), a cursor control device 614 (e.g., a mouse), and a signal generation device 616 (e.g., an integrated speaker). The computer system 600 may further include peripheral device 636 (e.g., wireless or wired communication devices, memory devices, storage devices, audio processing devices, video processing devices, etc. The computer system 600 may further include a Hardware based API logging framework 634 capable of executing incoming requests for services and emitting execution data responsive to the fulfillment of such incoming requests.

The secondary memory 618 may include a non-transitory machine-readable storage medium (or more specifically a machine-accessible storage medium) 631 on which is stored one or more sets of instructions (e.g., software 622) embodying any one or more of the methodologies or functions of business rules management mechanism 108 as described with reference to FIG. 1 and other figures described herein. The software 622 may also reside, completely or at least partially, within the main memory 604 and/or within the processor 602 during execution thereof by the computer system 600, the main memory 604 and the processor 602 also constituting machine-readable storage media. The software 622 may further be transmitted or received over a network 620 via the network interface card 608.

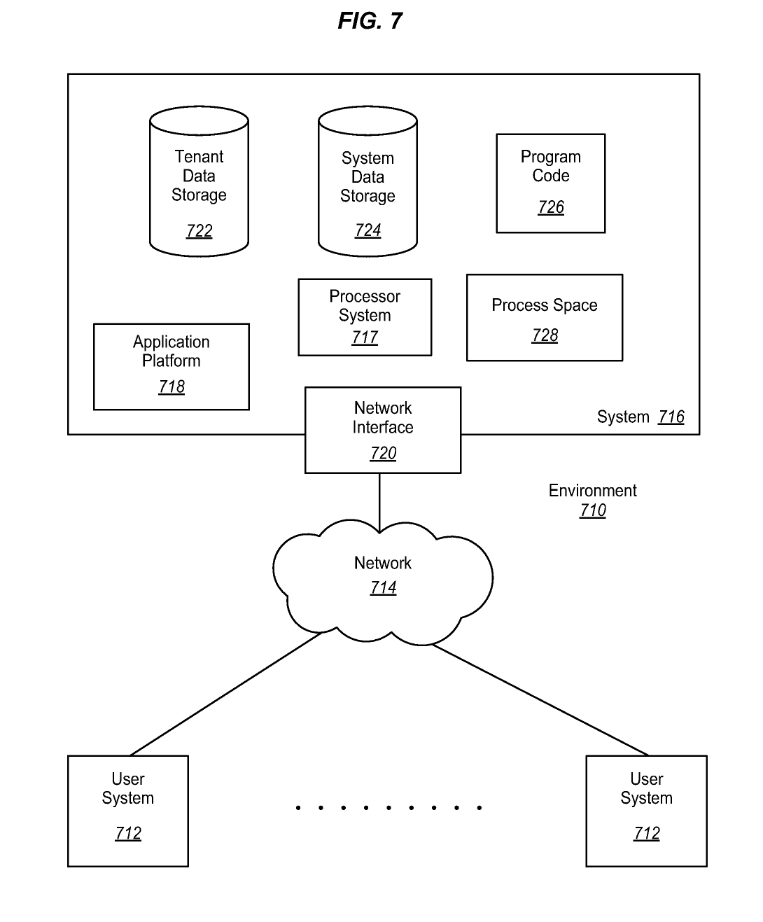

FIG. 7 illustrates a block diagram of an environment 710 wherein an on-demand database service might be used. Environment 710 may include user systems 712, network 714, system 716, processor system 717, application platform 718, network interface 720, tenant data storage 722, system data storage 724, program code 726, and process space 728. In other embodiments, environment 710 may not have all of the components listed and/or may have other elements instead of, or in addition to, those listed above.

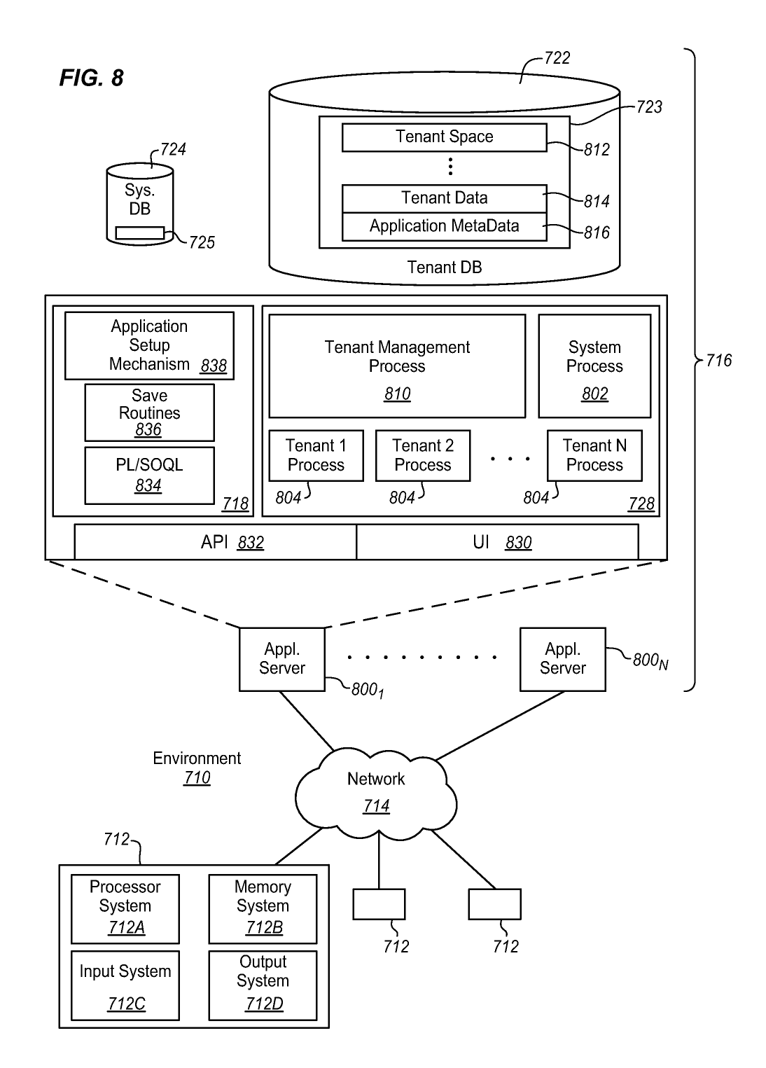

Environment 710 is an environment in which an on-demand database service exists. User system 712 may be any machine or system that is used by a user to access a database user system. For example, any of user systems 712 can be a handheld computing device, a mobile phone, a laptop computer, a work station, and/or a network of computing devices. As illustrated in herein FIG. 7 (and in more detail in FIG. 8) user systems 712 might interact via a network 714 with an on-demand database service, which is system 716.

An on-demand database service, such as system 716, is a database system that is made available to outside users that do not need to necessarily be concerned with building and/or maintaining the database system, but instead may be available for their use when the users need the database system (e.g., on the demand of the users). Some on-demand database services may store information from one or more tenants stored into tables of a common database image to form a multi-tenant database system (MTS). Accordingly, “on-demand database service 716” and “system 716” will be used interchangeably herein. A database image may include one or more database objects. A relational database management system (RDMS) or the equivalent may execute storage and retrieval of information against the database object(s). Application platform 718 may be a framework that allows the applications of system 716 to run, such as the hardware and/or software, e.g., the operating system. In an embodiment, on-demand database service 716 may include an application platform 718 that enables creation, managing and executing one or more applications developed by the provider of the on-demand database service, users accessing the on-demand database service via user systems 712, or third party application developers accessing the on-demand database service via user systems 712.

The users of user systems 712 may differ in their respective capacities, and the capacity of a particular user system 712 might be entirely determined by permissions (permission levels) for the current user. For example, where a salesperson is using a particular user system 712 to interact with system 716, that user system has the capacities allotted to that salesperson. However, while an administrator is using that user system to interact with system 716, that user system has the capacities allotted to that administrator. In systems with a hierarchical role model, users at one permission level may have access to applications, data, and database information accessible by a lower permission level user, but may not have access to certain applications, database information, and data accessible by a user at a higher permission level. Thus, different users will have different capabilities with regard to accessing and modifying application and database information, depending on a user's security or permission level.

Network 714 is any network or combination of networks of devices that communicate with one another. For example, network 714 can be any one or any combination of a LAN (local area network), WAN (wide area network), telephone network, wireless network, point-to-point network, star network, token ring network, hub network, or other appropriate configuration. As the most common type of computer network in current use is a TCP/IP (Transfer Control Protocol and Internet Protocol) network, such as the global internetwork of networks often referred to as the “Internet” with a capital “I,” that network will be used in many of the examples herein. However, it should be understood that the networks that one or more implementations might use are not so limited, although TCP/IP is a frequently implemented protocol.

User systems 712 might communicate with system 716 using TCP/IP and, at a higher network level, use other common Internet protocols to communicate, such as HTTP, FTP, AFS, WAP, etc. In an example where HTTP is used, user system 712 might include an HTTP client commonly referred to as a “browser” for sending and receiving HTTP messages to and from an HTTP server at system 716. Such an HTTP server might be implemented as the sole network interface between system 716 and network 714, but other techniques might be used as well or instead. In some implementations, the interface between system 716 and network 714 includes load sharing functionality, such as round-robin HTTP request distributors to balance loads and distribute incoming HTTP requests evenly over a plurality of servers. At least as for the users that are accessing that server, each of the plurality of servers has access to the MTS' data; however, other alternative configurations may be used instead.

In one embodiment, system 716, shown in FIG. 7, implements a web-based customer relationship management (CRM) system. For example, in one embodiment, system 716 includes application servers configured to implement and execute CRM software applications as well as provide related data, code, forms, webpages and other information to and from user systems 712 and to store to, and retrieve from, a database system related data, objects, and Webpage content. With a multi-tenant system, data for multiple tenants may be stored in the same physical database object, however, tenant data typically is arranged so that data of one tenant is kept logically separate from that of other tenants so that one tenant does not have access to another tenant's data, unless such data is expressly shared. In certain embodiments, system 716 implements applications other than, or in addition to, a CRM application. For example, system 716 may provide tenant access to multiple hosted (standard and custom) applications, including a CRM application. User (or third party developer) applications, which may or may not include CRM, may be supported by the application platform 718, which manages creation, storage of the applications into one or more database objects and executing of the applications in a virtual machine in the process space of the system 716.

One arrangement for elements of system 716 is shown in FIG. 7, including a network interface 720, application platform 718, tenant data storage 722 for tenant data 723, system data storage 724 for system data 725 accessible to system 716 and possibly multiple tenants, program code 726 for implementing various functions of system 716, and a process space 728 for executing MTS system processes and tenant-specific processes, such as running applications as part of an application hosting service. Additional processes that may execute on system 716 include database indexing processes.

Several elements in the system shown in FIG. 7 include conventional, well-known elements that are explained only briefly here. For example, each user system 712 could include a desktop personal computer, workstation, laptop, PDA, cell phone, or any wireless access protocol (WAP) enabled device or any other computing device capable of interfacing directly or indirectly to the Internet or other network connection. User system 712 typically runs an HTTP client, e.g., a browsing program, such as Microsoft's Internet Explorer browser, Netscape's Navigator browser, Opera's browser, or a WAP-enabled browser in the case of a cell phone, PDA or other wireless device, or the like, allowing a user (e.g., subscriber of the multi-tenant database system) of user system 712 to access, process and view information, pages and applications available to it from system 716 over network 714. Each user system 712 also typically includes one or more user interface devices, such as a keyboard, a mouse, trackball, touch pad, touch screen, pen or the like, for interacting with a graphical user interface (GUI) provided by the browser on a display (e.g., a monitor screen, LCD display, etc.) in conjunction with pages, forms, applications and other information provided by system 716 or other systems or servers. For example, the user interface device can be used to access data and applications hosted by system 716, and to perform searches on stored data, and otherwise allow a user to interact with various GUI pages that may be presented to a user. As discussed above, embodiments are suitable for use with the Internet, which refers to a specific global internetwork of networks. However, it should be understood that other networks can be used instead of the Internet, such as an intranet, an extranet, a virtual private network (VPN), a non-TCP/IP based network, any LAN or WAN or the like.

According to one embodiment, each user system 712 and all of its components are operator configurable using applications, such as a browser, including computer code run using a central processing unit such as an Intel Pentium® processor or the like. Similarly, system 716 (and additional instances of an MTS, where more than one is present) and all of their components might be operator configurable using application(s) including computer code to run using a central processing unit such as processor system 717, which may include an Intel Pentium® processor or the like, and/or multiple processor units. A computer program product embodiment includes a machine-readable storage medium (media) having instructions stored thereon/in which can be used to program a computer to perform any of the processes of the embodiments described herein. Computer code for operating and configuring system 716 to intercommunicate and to process webpages, applications and other data and media content as described herein are preferably downloaded and stored on a hard disk, but the entire program code, or portions thereof, may also be stored in any other volatile or non-volatile memory medium or device as is well known, such as a ROM or RAM, or provided on any media capable of storing program code, such as any type of rotating media including floppy disks, optical discs, digital versatile disk (DVD), compact disk (CD), microdrive, and magneto-optical disks, and magnetic or optical cards, nanosystems (including molecular memory ICs), or any type of media or device suitable for storing instructions and/or data. Additionally, the entire program code, or portions thereof, may be transmitted and downloaded from a software source over a transmission medium, e.g., over the Internet, or from another server, as is well known, or transmitted over any other conventional network connection as is well known (e.g., extranet, VPN, LAN, etc.) using any communication medium and protocols (e.g., TCP/IP, HTTP, HTTPS, Ethernet, etc.) as are well known. It will also be appreciated that computer code for implementing embodiments can be implemented in any programming language that can be executed on a client system and/or server or server system such as, for example, C, C++, HTML, any other markup language, Java™, JavaScript, ActiveX, any other scripting language, such as VBScript, and many other programming languages as are well known may be used. (Java™ is a trademark of Sun Microsystems, Inc.).

According to one embodiment, each system 716 is configured to provide webpages, forms, applications, data and media content to user (client) systems 712 to support the access by user systems 712 as tenants of system 716. As such, system 716 provides security mechanisms to keep each tenant's data separate unless the data is shared. If more than one MTS is used, they may be located in close proximity to one another (e.g., in a server farm located in a single building or campus), or they may be distributed at locations remote from one another (e.g., one or more servers located in city A and one or more servers located in city B). As used herein, each MTS could include one or more logically and/or physically connected servers distributed locally or across one or more geographic locations. Additionally, the term “server” is meant to include a computer system, including processing hardware and process space(s), and an associated storage system and database application (e.g., OODBMS or RDBMS) as is well known in the art. It should also be understood that “server system” and “server” are often used interchangeably herein. Similarly, the database object described herein can be implemented as single databases, a distributed database, a collection of distributed databases, a database with redundant online or offline backups or other redundancies, etc., and might include a distributed database or storage network and associated processing intelligence.

FIG. 8 also illustrates environment 710. However, in FIG. 8 elements of system 716 and various interconnections in an embodiment are further illustrated. FIG. 8 shows that user system 712 may include processor system 712A, memory system 712B, input system 712C, and output system 712D. FIG. 8 shows network 714 and system 716. FIG. 8 also shows that system 716 may include tenant data storage 722, tenant data 723, system data storage 724, system data 725, User Interface (UI) 830, Application Program Interface (API) 832, PL/SOQL 834, save routines 836, application setup mechanism 838, applications servers 800₁-800_{N}, system process space 802, tenant process spaces 804, tenant management process space 810, tenant storage area 812, user storage 814, and application metadata 816. In other embodiments, environment 710 may not have the same elements as those listed above and/or may have other elements instead of, or in addition to, those listed above.

User system 712, network 714, system 716, tenant data storage 722, and system data storage 724 were discussed above in FIG. 7. Regarding user system 712, processor system 712A may be any combination of one or more processors. Memory system 712B may be any combination of one or more memory devices, short term, and/or long term memory. Input system 712C may be any combination of input devices, such as one or more keyboards, mice, trackballs, scanners, cameras, and/or interfaces to networks. Output system 712D may be any combination of output devices, such as one or more monitors, printers, and/or interfaces to networks. As shown by FIG. 8, system 716 may include a network interface 720 (of FIG. 7) implemented as a set of HTTP application servers 800, an application platform 718, tenant data storage 722, and system data storage 724. Also shown is system process space 802, including individual tenant process spaces 804 and a tenant management process space 810. Each application server 800 may be configured to tenant data storage 722 and the tenant data 723 therein, and system data storage 724 and the system data 725 therein to serve requests of user systems 712. The tenant data 723 might be divided into individual tenant storage areas 812, which can be either a physical arrangement and/or a logical arrangement of data. Within each tenant storage area 812, user storage 814 and application metadata 816 might be similarly allocated for each user. For example, a copy of a user's most recently used (MRU) items might be stored to user storage 814. Similarly, a copy of MRU items for an entire organization that is a tenant might be stored to tenant storage area 812. A UI 830 provides a user interface and an API 832 provides an application programmer interface to system 716 resident processes to users and/or developers at user systems 712. The tenant data and the system data may be stored in various databases, such as one or more Oracle™ databases.

Application platform 718 includes an application setup mechanism 838 that supports application developers' creation and management of applications, which may be saved as metadata into tenant data storage 722 by save routines 836 for execution by subscribers as one or more tenant process spaces 804 managed by tenant management process 810 for example. Invocations to such applications may be coded using PL/SOQL 834 that provides a programming language style interface extension to API 832. A detailed description of some PL/SOQL language embodiments is discussed in commonly owned U.S. Pat. No. 7,730,478 entitled, “Method and System for Allowing Access to Developed Applicants via a Multi-Tenant Database On-Demand Database Service”, issued Jun. 1, 2010 to Craig Weissman, which is incorporated in its entirety herein for all purposes. Invocations to applications may be detected by one or more system processes, which manage retrieving application metadata 816 for the subscriber making the invocation and executing the metadata as an application in a virtual machine.

Each application server 800 may be communicably coupled to database systems, e.g., having access to system data 725 and tenant data 723, via a different network connection. For example, one application server 800₁ might be coupled via the network 714 (e.g., the Internet), another application server 800_{N-1} might be coupled via a direct network link, and another application server 800_{N} might be coupled by yet a different network connection. Transfer Control Protocol and Internet Protocol (TCP/IP) are typical protocols for communicating between application servers 800 and the database system. However, it will be apparent to one skilled in the art that other transport protocols may be used to optimize the system depending on the network interconnect used.

In certain embodiments, each application server 800 is configured to handle requests for any user associated with any organization that is a tenant. Because it is desirable to be able to add and remove application servers from the server pool at any time for any reason, there is preferably no server affinity for a user and/or organization to a specific application server 800. In one embodiment, therefore, an interface system implementing a load balancing function (e.g., an F5 Big-IP load balancer) is communicably coupled between the application servers 800 and the user systems 712 to distribute requests to the application servers 800. In one embodiment, the load balancer uses a least connections algorithm to route user requests to the application servers 800. Other examples of load balancing algorithms, such as round robin and observed response time, also can be used. For example, in certain embodiments, three consecutive requests from the same user could hit three different application servers 800, and three requests from different users could hit the same application server 800. In this manner, system 716 is multi-tenant, wherein system 716 handles storage of, and access to, different objects, data and applications across disparate users and organizations.

As an example of storage, one tenant might be a company that employs a sales force where each salesperson uses system 716 to manage their sales process. Thus, a user might maintain contact data, leads data, customer follow-up data, performance data, goals and progress data, etc., all applicable to that user's personal sales process (e.g., in tenant data storage 722). In an example of a MTS arrangement, since all of the data and the applications to access, view, modify, report, transmit, calculate, etc., can be maintained and accessed by a user system having nothing more than network access, the user can manage his or her sales efforts and cycles from any of many different user systems. For example, if a salesperson is visiting a customer and the customer has Internet access in their lobby, the salesperson can obtain critical updates as to that customer while waiting for the customer to arrive in the lobby.

While each user's data might be separate from other users' data regardless of the employers of each user, some data might be organization-wide data shared or accessible by a plurality of users or all of the users for a given organization that is a tenant. Thus, there might be some data structures managed by system 716 that are allocated at the tenant level while other data structures might be managed at the user level. Because an MTS might support multiple tenants including possible competitors, the MTS should have security protocols that keep data, applications, and application use separate. Also, because many tenants may opt for access to an MTS rather than maintain their own system, redundancy, up-time, and backup are additional functions that may be implemented in the MTS. In addition to user-specific data and tenant specific data, system 716 might also maintain system level data usable by multiple tenants or other data. Such system level data might include industry reports, news, postings, and the like that are sharable among tenants.

In certain embodiments, user systems 712 (which may be client systems) communicate with application servers 800 to request and update system-level and tenant-level data from system 716 that may require sending one or more queries to tenant data storage 722 and/or system data storage 724. System 716 (e.g., an application server 800 in system 716) automatically generates one or more SQL statements (e.g., one or more SQL queries) that are designed to access the desired information. System data storage 724 may generate query plans to access the requested data from the database.

Each database can generally be viewed as a collection of objects, such as a set of logical tables, containing data fitted into predefined categories. A “table” is one representation of a data object, and may be used herein to simplify the conceptual description of objects and custom objects. It should be understood that “table” and “object” may be used interchangeably herein. Each table generally contains one or more data categories logically arranged as columns or fields in a viewable schema. Each row or record of a table contains an instance of data for each category defined by the fields. For example, a CRM database may include a table that describes a customer with fields for basic contact information such as name, address, phone number, fax number, etc. Another table might describe a purchase order, including fields for information such as customer, product, sale price, date, etc. In some multi-tenant database systems, standard entity tables might be provided for use by all tenants. For CRM database applications, such standard entities might include tables for Account, Contact, Lead, and Opportunity data, each containing pre-defined fields. It should be understood that the word “entity” may also be used interchangeably herein with “object” and “table”.

In some multi-tenant database systems, tenants may be allowed to create and store custom objects, or they may be allowed to customize standard entities or objects, for example by creating custom fields for standard objects, including custom index fields. U.S. patent application Ser. No. 10/817,161, filed Apr. 2, 2004, entitled “Custom Entities and Fields in a Multi-Tenant Database System”, and which is hereby incorporated herein by reference, teaches systems and methods for creating custom objects as well as customizing standard objects in a multi-tenant database system. In certain embodiments, for example, all custom entity data rows are stored in a single multi-tenant physical table, which may contain multiple logical tables per organization. It is transparent to customers that their multiple “tables” are in fact stored in one large table or that their data may be stored in the same table as the data of other customers.

While one or more implementations have been described by way of example and in terms of the specific embodiments, it is to be understood that one or more implementations are not limited to the disclosed embodiments. To the contrary, it is intended to cover various modifications and similar arrangements as would be apparent to those skilled in the art. Therefore, the scope of the appended claims should be accorded the broadest interpretation so as to encompass all such modifications and similar arrangements. It is to be understood that the above description is intended to be illustrative, and not restrictive.

What is claimed is:

1. A computer-implemented method comprising:
generating, at a first computing system, configuration settings to customize business rules to process data transactions, wherein the business rules are processed by a business rules engine at a second computing system;
customizing one or more business rules by applying one or more configuration settings to the one or more business rules; and
facilitating the business rules engine residing on the second computing system to process one or more data transactions based on the one or more customized business rules, wherein the one or more customized business rules guide processing of the one or more data transactions and provide information relating to how one or more business rules are matched with the one or more data transactions.

2. The computer-implemented method of claim 1, further comprising communicating the configuration settings from the first computing system to the business rules engine residing at the second computing system via a business rules Application Programming Interface (API) at the first computing system.

3. The computer-implemented method of claim 1, further comprising generating results of the processing of the one or more data transactions, wherein the results include one or more of stage information relating to each stage of the processing, action information relating to each action taken during the processing, success information if the processing succeeds, and failure information if the processing fails.

4. The computer-implemented method of claim 3, wherein the processing succeeds if at least the one or more business rules match the one or more data transactions.

5. The computer-implemented method of claim 1, wherein the processing fails if at least the one or more business rules does not match the one or more data transactions.

6. The computer-implemented method of claim 1, wherein generating is performed using custom objects of a business rules process framework at the first computing system.

7. The computer-implemented method of claim 1, wherein facilitating is provided by the business rules API of the business rules configuration framework at the first computing system.

8. The computer-implemented method of claim 1, wherein the configuration settings and data relating to the data transactions are stored at a database coupled to the first computing system.

9. The computer-implemented method of claim 3, further comprising registering results as instances of an audit log custom object, and providing the results to a third computing system for display using a display device coupled to the third computing system.

10. A non-transitory machine-readable medium carrying one or more sequences of instructions, which instructions, when executed by one or more processors, cause the one or more processors to carry out the steps of:
generating, at a first computing system, configuration settings to customize business rules to process data transactions, wherein the business rules are processed by a business rules engine at a second computing system;
customizing one or more business rules by applying one or more configuration settings to the one or more business rules; and
facilitating the business rules engine residing on the second computing system to process one or more data transactions based on the one or more customized business rules, wherein the one or more customized business rules guide processing of the one or more data transactions and provide information relating to how one or more business rules are matched with the one or more data transactions.

11. The non-transitory machine-readable medium of claim 10, wherein the instructions further include instructions for carrying out the step of: communicating the configuration settings from the first computing system to the business rules engine residing at the second computing system via a business rules Application Programming Interface (API) at the first computing system.

12. The non-transitory machine-readable medium of claim 10, wherein the instructions further include instructions for carrying out the step of: generating results of the processing of the one or more data transactions, wherein the results include one or more of stage information relating to each stage of the processing, action information relating to each action taken during the processing, success information if the processing succeeds, and failure information if the processing fails.

13. The non-transitory machine-readable medium of claim 12, wherein the processing succeeds if at least the one or more business rules match the one or more data transactions.

14. The non-transitory machine-readable medium of claim 10, wherein the processing fails if at least the one or more business rules does not match the one or more data transactions.

15. The non-transitory machine-readable method of claim 10, wherein generating is performed using custom objects of a business rules process framework at the first computing system.

16. An apparatus comprising:
a processor; and
one or more stored sequences of instructions which, when executed by the processor, cause the processor to carry out the steps of:
generating, at a first computing system, configuration settings to customize business rules to process data transactions, wherein the business rules are processed by a business rules engine at a second computing system,
customizing one or more business rules by applying one or more configuration settings to the one or more business rules, and
facilitating the business rules engine residing on the second computing system to process one or more data transactions based on the one or more customized business rules, wherein the one or more customized business rules guide processing of the one or more data transactions and provide information relating to how one or more business rules are matched with the one or more data transactions.

17. The apparatus of claim 16, wherein the processor is further to carry out the step of communicating the configuration settings from the first computing system to the business rules engine residing at the second computing system via a business rules Application Programming Interface (API) at the first computing system.

18. The apparatus of claim 16, wherein the processor is further to carry out the steps of:
generating results of the processing of the one or more data transactions, wherein the results include one or more of stage information relating to each stage of the processing, action information relating to each action taken during the processing, success information if the processing succeeds, and failure information if the processing fails.

19. The apparatus of claim 18, wherein the processing succeeds if at least the one or more business rules match the one or more data transactions

20. The apparatus of claim 16, wherein the processing fails if at least the one or more business rules does not match the one or more data transactions.
